(19) United States
(12) Patent Application Publication
(10) Pub. No.: US 2017/0213276 A1
(43) Pub. Date: Jul. 27, 2017

(54) SYSTEM FOR MONITORING ARTICLES SELECTED BY A SHOPPER IN A SHOP

(71) Applicants: Jose Antonio QUINTERO TRAVERSO, Puerto Real (ES); Enrique Alfonso QUINTERO TRAVERSO, Puerto Real (ES); Jose Manuel REINA RODRIGUEZ, Puerto Real (ES)

(72) Inventors: Jose Antonio QUINTERO TRAVERSO, Puerto Real (ES); Enrique Alfonso QUINTERO TRAVERSO, Puerto Real (ES); Jose Manuel REINA RODRIGUEZ, Puerto Real (ES)

(21) Appl. No.: 15/515,128

(22) PCT Filed: Sep. 30, 2015
(86) PCT No.: PCT/ES2015/070713

§ 371 Date: Mar. 28, 2017

(30) Foreign Application Priority Data
Sep. 30, 2014 (ES) P201431442

(51) Int. Cl. G06Q 30/06; G08B 13/24

(52) U.S. Cl. CPC G06Q 30/0633; G08B 13/2402

(57) ABSTRACT

A commercial establishment furnishes to its customers, upon customer identification, a shopping carrier (1) in which the shopper can place the articles selected until the shopper reaches the point of purchase (7) or dispensing/collecting units (2). Beacons (4) are disposed along the itinerary for tracking and locating the position of the shopping carrier (1). The articles placed in or taken out of the shopping carrier (1) are detected by means of sensors (3) arranged on the carrier. The anti-shoplifting devices (5) attached to the articles selected and redesigned to furnish an all-purpose identifier code. The system serves to monitor the shopping carriers (1) used by shoppers during the time they are shopping in a retail space and collects data relating to shopper behaviour during passage through the retail space.

### OBJECT OF THE INVENTION

This invention relates to an system for monitoring articles selected by shoppers at a shop, intended first and foremost to avoid the frequent shoplifting that occurs at certain shops where assorted items, such as clothing and the like, are retailed, by monitoring customer shopping time and route through the interior of the shop, all by using a shopping carrier, such as a tote bag, a basket, or the like, intended to hold the articles selected by the shopper before coming to and passing through the corresponding point of purchase.

A first object of the system is to monitor the shopping carriers used by shoppers while shopping in commercial establishments and the articles made available for sale that are to be carried by the shopper while in or moving through the shop, until the shopper passes through the point of purchase or the shopping carrier dispensing/collecting unit, if no purchase is made, where the said shopping carriers are periodically restocked by the retail enterprise where shopping takes place.

A further object of the invention is to collect data on shopper behaviour during their passage through the retail space, achieved by installing electronic devices that collect information on the route taken and the time spent by the shopping carriers used by shoppers while they are in the shop, so that all these data can be used for commercial and/or information purposes and can further be related to the sales receipt.

### BACKGROUND OF THE INVENTION

No system for tracking shoppers on their route through a commercial establishment or for monitoring the articles selected on that route and placed in a shopping carrier is known, nor is there any known system having the capabilities and functions of the invention.

### DESCRIPTION OF THE INVENTION

The system put forward is based on placing a plurality of shopping carriers, such as a tote bag, a basket, or the like, in an appropriate holder, such as a dispensing unit, from which shoppers can take a shopping carrier after they have identified themselves.

To that end, the shopping carrier has, in its handle or any other suitable part, a module for collecting data while the shopper is moving through the retail space, each shopping carrier having its own unique identifier code that can later be used to compare the data collected with the sales receipt.

This module is connected to an internal battery having a charge of sufficient duration to last as long as the shopper's estimated shopping time.

The holder in which the shopping carriers are placed comprises a dispensing unit used to deliver each shopping carrier to a shopper upon shopper identification, that is, shoppers can only take a shopping carrier if they identify themselves by some form of code or electronic device, such as a charge card, I.D. card, mobile telephone, etc., such that, upon shopper identification, the module included in the shopping carrier, with its identifier code supplied by wireless means by the dispensing/collecting unit itself and stored by the shopping carrier, can be used to more clearly relate the shopper with his or her path of movement, whereby each shopper may take only one shopping carrier at a time.

The system also includes a positioning beacon that emits information on the position of the shopping carrier, whereby the beacon emits a unique signal giving its position, there being as many positioning beacons as the retail shop's management chooses as may be appropriate for data collection purposes.

While the shopping carrier is not in use, the system will have a charging system, that is, there will be a module that charges the battery located inside the shopping carrier, whereby if the battery attains its maximum charge level before the shopping carrier has been removed from its location or from the dispensing unit, the shopping carrier will halt the charging procedure, and what is more, while the shopping carrier is in the dispensing unit, no position or time data will be received, since there is no need.

The system also preferably includes one or more shopping carrier collecting/dispensing units located at the point of purchase and wherever elsewhere may be deemed appropriate, the purpose of which is to retrieve from the shopping carrier all the information it has stored, such that the data collected can be combined to issue the corresponding sales receipt or to perform market studies on the basis of the data on the articles purchased, the route taken while in the shop, the time used for shopping, along with other data.

In addition, the invention also provides that conventional anti-shoplifting devices on the garments or certain articles in the commercial establishment will be modified, i.e., redesigned, so that they not only perform the function of preventing theft of the item that has the anti-shoplifting device attached but in certain situations will also transmit an identification code enabling the item to be tracked.

A further characteristic of the system is that it includes a unit in which to place articles on exiting, for instance, in the case of a clothing establishment, a fitting room, whereby for purposes of tracking the articles and thanks to the automated functions of the anti-shoplifting devices, the unit at the fitting room exit will detect placement of items deselected by the shopper, then being detected or tracked in the shop within the corresponding retail space, a function applicable to commercial establishments of all kinds.

Accordingly, the commercial establishment will have a certain number of beacons, as already mentioned, at management's discretion, simply transmitters sending location-related identification signals, the data being transmitted continuously and uninterruptedly, and in addition there is an automated system for modifying or reprogramming the conventional anti-shoplifting devices ordinarily placed on articles to prevent them from being stolen, whereby on passing through the door of the commercial establishment only the passage of articles is detected, in no case identification data, so that the automatic redesign of these anti-shoplifting devices yields a single identifier code, thereby establishing a database that will relate the anti-shoplifting device with the identity of the article on which it has been placed without altering the article.

All such that once the shopping carrier has been taken from the reprogramming unit, the main work begins, using the energy from a battery located in the unit to turn it on in listening mode, so that the codes transmitted by the different beacons are picked up by the shopping carrier to collect information on the path of movement followed by the shopping carrier along with time data and other data such as customer identification, route, items, etc.

The beacons will be arranged so that the codes from one do not interfere with the codes from another for proper identification of location.

Lastly, the shopping carrier will include two wireless sensors located one above the other at a sufficient distance from each other so that when an article is placed in the shopping carrier, the shopping carrier will recognise the corresponding modified anti-shoplifting device. Depending on the order of detection by the said sensors, the system can tell whether the article has been placed in or taken out of the shopping carrier, i.e., the order of the readings by the sensors as the article passes into or out of the shopping carrier tells whether the article has been placed in or taken out of the shopping carrier.

On detecting that an article has been placed in the shopping carrier, the article will emit the anti-shoplifting device identifier to be stored by the shopping carrier, whereby the shopping carrier can track the placement and removal of each article selected.

The anti-shoplifting device will have a tampering sensor to detect whether there has been any attempt to remove the article, thereby generating in real time, by means of software, a warning that the device has been tampered with on downloading the information from the shopping carrier into the system.

Where a shopper enters a fitting room or area where there is a container for leaving unwanted articles which will not be purchased, the shopper should place the item in the container designated for that purpose, whereby the system will detect that the item has been placed in the container in the same way as in the shopping carrier.

### DESCRIPTION OF THE DRAWINGS

Supplementing the description below and to aid in providing a better understanding of the characteristics of the invention, there follows, as an integral part of the description, a set of drawings illustrating a practical example of a preferred embodiment of the invention, not intended to limit the invention in any way, including the following representations:

FIG. 1 is a schematic diagram of an embodiment of the system of the invention.

FIG. 2 is a representation of a possible shopping carrier included in the system of the invention, in the form of a tote bag in which to place the articles selected in the commercial establishment, the said tote bag having a handle interchangeable with the body of the tote bag.

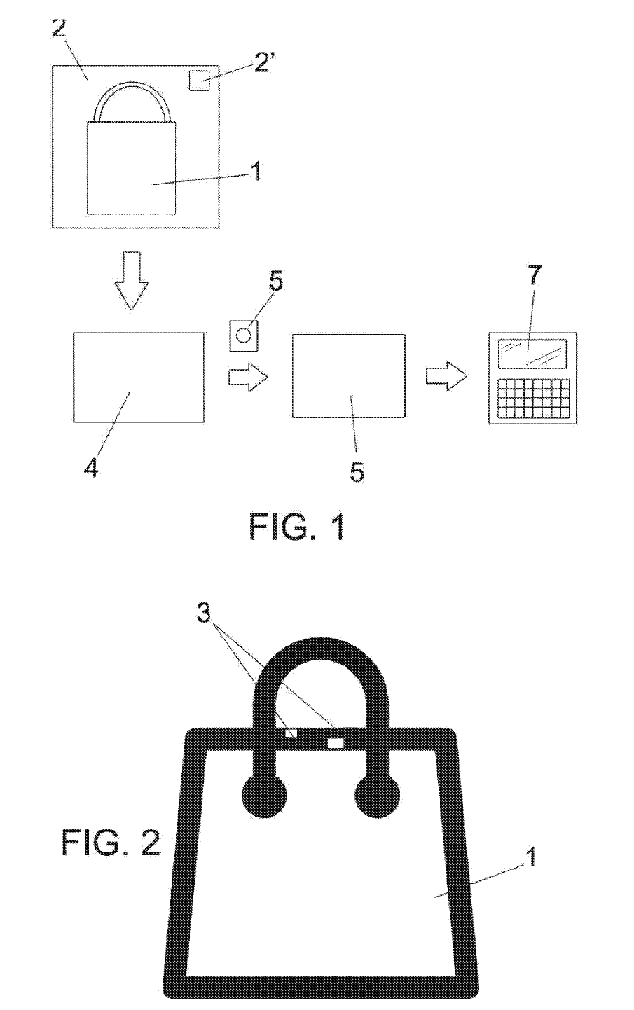

### PREFERRED EMBODIMENT OF THE INVENTION

As shown in the above-mentioned Figures, the system of the invention includes a shopping carrier (1), in the example shown a tote bag (1) designed to receive the different articles selected by a shopper in a commercial establishment, before payment for the articles at the corresponding point of purchase (7), if a purchase is made, or otherwise before deposit in a dispensing/collecting unit (2).

To this end, there is provided a dispenser (2) which dispenses each shopping carrier upon shopper identification, whereby the shopper may only collect a shopping carrier (1) if he or she identifies him or herself by means of an electronic device, bar code, charge card, identification document, mobile telephone, or the like, such that when the shopper has been identified, an identifier code will be wirelessly transmitted and stored by the shopping carrier (1), which includes a module (3) designed to collect data as the shopper moves around within the retail space, each shopping carrier (1) having its own unique identifier code, so that the data can subsequently be compared with the sales receipt, and in addition there is an internal battery having a charge of sufficient duration to last for the shopper's estimated shopping time, along with the corresponding charging connectors (1′). The shopping carrier dispenser (2) has an appropriate element or means (2′) for the shopper to enter his or her identification or code to be able to pick up a shopping carrier (1).

The itinerary through the commercial establishment will include a series of beacons (4), i.e., positioning beacons, which wirelessly transmit information regarding the position of the shopping carrier (1), which information is received by the shopping carrier (1).

The articles will, as is conventional, be equipped with an anti-shoplifting device (5), which will be appropriately redesigned so that, in addition to performing the function of preventing possible theft of the article, it can also perform the function of a location identifier code so that the article can be tracked. It may also include anti-tampering means.

When an article selected by the shopper is not placed in the shopping carrier (1), because the shopper is not interested in it and does not want to purchase it, it will be deposited in a container (6), where the article will be detected for final tracking of the route followed by the client with the shopping carrier (1) until the point of purchase (7) is reached, where the shopping carrier will be deposited in the dispensing/collecting unit (2).

In addition, the shopping carrier (1) is to be provided with a pair of wireless sensors (3) to detect and determine whether an article has been placed in and/or taken out of the shopping carrier (1), such that, logically, the shopping carrier (1) tracks every article placed in/taken out of it.

When the shopper is ready to pay for the articles selected and placed in the shopping carrier (1), the person at the point of purchase (7) will have the task of collecting the said shopping carrier (1), removing the articles from it, and verifying, by means of a unit located at the point of purchase (7), the data received, for which purpose the said unit wirelessly transmits a code. The code comprises interrogating the shopping carrier for its data, and the shopping carrier will download the available information it contains, to be added to the information on the sales receipt. The information will comprise the identification of the shopper who picked up the shopping carrier (1), the route taken through the retail space, and the anti-shoplifting devices (5) that were placed in and taken out of the shopping carrier (1), which information will be contrasted, by computer, with the articles that are being purchased and also with the container (6) for depositing unwanted articles, to see whether the shopper has selected any article and then left it in the said container (6).

The shopping carrier (1) dispensing/collecting unit (2) comprises a system for recognising an identification document (2″), ideally a [Spanish] National Identity Document, being provided with a slot (8) for insertion of the identity document, such that upon insertion a mechanism (8) will place it in a position inside the unit where there will be two cameras (8) situated on opposite sides of the card to image both sides of the shopper's identification document, whereupon the said cameras will take images of the document, such that by means of image processing sufficient details, for instance, the shopper's picture and personal particulars, can be obtained to be able to recognise the new shopper.

The outside of the unit will have a camera (9) and a touchpad (9). The camera will process the image it is viewing at the time and compare it to the face of the person on the document that has been inserted, such that it will be able to verify that the person who has inserted the document is the same.

The screen (9) will display a form prepared on the spot containing the particulars taken from the document and a picture of the shopper. The screen (9) will be a touchscreen, so that it can display a touchpad (9) for the shopper to correct any incorrect information and input other details, such as a telephone number or e-mail address, which cannot be collected from the identification document inserted.

On completion of the procedure, the mechanism will expel the identification document inserted through the same slot (8) used to insert it, and a message will be sent to the address entered by the shopper with his or her identification, which message will be a code, optimally displayed on the screen of a mobile telephone or any other means capable of displaying the code, to be brought up into proximity of the code reader (2′) located on the dispensing unit (2), which will then dispense a shopping carrier (1).

1. A system for monitoring articles selected by a shopper in a shop, designed to track the route taken by each shopper inside a commercial establishment retailing articles and to monitor the articles the shopper selects and places in a shopping carrier (1), such as a tote bag, basket, or the like, before reaching a corresponding point of purchase (7) to pay for the articles purchased or return the shopping carrier (1), the system comprising:
a dispensing unit (2) for dispensing one shopping carrier (1) per shopper upon proper identification of the shopper, the shopping carrier (1) including a module (3) designed to collect data during the shopper's passage through the commercial establishment, including the shopper's identification; and
a plurality of beacons (4) that transmit information relating to the position of the shopping carrier (1) at any given time, the beacons having been previously arranged along a route of the shopper's passage through the commercial establishment, and further in that the shopping carrier (1) also includes a pair of sensors (3) to detect both the placement and the removal of articles, the articles being identified by corresponding anti-shoplifting devices (5) attached to the articles, each anti-shoplifting device (5) being automatically reprogrammable to transmit a corresponding article identifier code independently of the code included by the anti-shoplifting device (5) itself.

2. System for monitoring articles selected by a shopper in a shop according to claim 1, further comprising:
a container (6) to receive unwanted articles previously selected by the shopper; and/or
a unit at the point of purchase (7) itself, and/or at the dispensing/collecting units (2), which unit retrieves all the data stored and acquired during the shopper's passage, from the articles purchased, and from those unwanted items returned to the container (6).

3. System for monitoring articles selected by a shopper in a shop according to claim 1, wherein the data module (3) in the shopping carrier (1) is connected to an internal chargeable battery.

4. System for monitoring articles selected by a shopper in a shop according to claim 1, wherein the unique signals from the positioning beacons (4) identifying the position of the shopping carrier (1) are wireless signals.

5. System for monitoring articles selected by a shopper in a shop according to claim 2, wherein the dispensing/collecting unit (2) wirelessly transmits an interrogation code to the shopping carrier (1) for the shopping carrier's data, the data from the unit being capable of being downloaded together with the information collected by the shopping carrier (1).

6. System for monitoring articles selected by a shopper in a shop according to claim 1, wherein at least one shopping carrier (1) dispensing/collecting unit (2) has means for recognising an identification document (2′) equipped with a camera (9′), a touchscreen (9), and a touchpad (9) and means for sending messages to an address input by the shopper with his or her identification, in the form of a code which activates the dispenser so that the dispenser releases a shopping carrier (1).
